(19) United States
(12) Patent Application Publication
(10) Pub. No.: US 2012/0192359 A1
(43) Pub. Date: Aug. 2, 2012

(54) CABLE STRIPPER WITH MARKING STRUCTURE

(75) Inventor: CHENG-HUI WANG, TAIPEI (TW)

(73) Assignee: EZCONN CORPORATION, TAIPEI (TW)

(21) Appl. No.: 13/015,853

(22) Filed: Jan. 28, 2011

(51) Int. Cl. H02G 1/12

(52) U.S. Cl. 7/107

(57) ABSTRACT

A cable stripper with marking structure includes an upper main body, a lower main body, a blade seat installed on the lower main body, a micro-adjustable locating structure including a fixing rod connected with the upper main body and a locating plate movably connected on the fixing rod, and a marking structure including a support body fixed with the lower main body and a marking member connected with the support body and extending from the support body by a certain length. A free end of a coaxial cable can be inserted into the marking structure until the free end of the coaxial cable completely abuts against the locating plate. Then, the coaxial cable is rotated to form a mark on the surface of the skin of the coaxial cable. With the mark, the coaxial cable is prepared to insert into a terminal connector by a correct insertion depth.

### BACKGROUND OF THE INVENTION

1. Field of the Invention

The present invention relates generally to a cable stripper with marking structure, and more particularly to a cable stripper, which can form a mark on the surface of the skin of a coaxial cable. With the mark, the coaxial cable is prepared to connect with and insert into a terminal connector by a correct insertion depth.

2. Description of the Related Art

It is well known that a coaxial cable connector is connectable with an auxiliary interface connector to electrically connect a coaxial cable with various electronic devices such as TV, CB, FM radio and radio system.

The coaxial cable connector includes a terminal connector for mechanically and electrically connecting a coaxial cable with a threaded interface connector of an electronic device. Before installing the coaxial cable onto the terminal connector, a free end of the coaxial cable must be first prepared. That is, a certain length of skin of the coaxial cable must be removed by means of a cable stripper and the external conductor must be folded over to expose the insulator and the internal conductor.

FIG. 1 shows a conventional cable stripper 10, which includes an upper main body 11 and a lower main body 12 pivotally connected with the upper main body 11. The cable stripper 10 further includes a spring 13 installed between the upper and lower main bodies 11, 12. When not used, front ends of the upper and lower main bodies 11, 12 of the cable stripper 10 are in a closed state. The cable stripper 10 further includes a blade seat 14 positioned at the front end of the lower main body 12. When a pressing force is applied to a rear end of the lower main body 12, the blade seat 14 is forcedly moved away from the front end of the upper main body 11, whereby the front ends of the upper and lower main bodies 11, 12 become in an open state. Then, the free end of the coaxial cable is placed on a blade 15 of the blade seat 14 and then the lower main body 12 is released from the pressing force. At this time, the front ends of the upper and lower main bodies 11, 12 are restored to the closed state, whereby the coaxial cable is clamped between the front ends of the upper and lower main bodies 11, 12. Then, the cable stripper 10 is rotated to make the blade 15 circumferentially cut the skin of the coaxial cable. The conventional cable stripper is simply used to strip the cable, while lacking marking function. Therefore, the coaxial cable has no mark of insertion depth on the surface. As a result, when connecting the coaxial cable with a terminal connector (such as a BNC connector, an RCA connector, an IEC connector or the like), it often takes place that the coaxial cable is not fully inserted into the terminal connector to cause short-circuit. This problem must be overcome.

### SUMMARY OF THE INVENTION

A primary object of the present invention is to provide a cable stripper with marking structure. The cable stripper includes a micro-adjustable locating structure adaptable to various coaxial cables with different specifications for locating the coaxial cables. The cable stripper further includes a marking member, which can form a mark on the surface of the skin of a coaxial cable. With the mark, the coaxial cable is prepared to connect with and insert into a terminal connector by a correct insertion depth.

To achieve the above and other objects, the cable stripper with marking structure of the present invention includes: an upper main body having a first connection hole formed on one side of the upper main body; a lower main body pivotally connected with the upper main body, the lower main body having a second connection hole and a press section at a rear end of the lower main body; a blade seat installed at a front end of the lower main body, a blade being mounted on the blade seat, when a pressing force is applied to the press section of the lower main body, the blade seat being forcedly moved away from the front end of the upper main body, whereby the front ends of the upper and lower main bodies become in an open state; a micro-adjustable locating structure including a fixing rod connected in the first connection hole of the upper main body and a locating plate movably mounted on the fixing rod; and a marking structure including a support body fixed in the second connection hole of the lower main body and a marking member connected with the support body and extending from the support body by a certain length. A free end of a coaxial cable can be inserted into the marking structure until the free end of the coaxial cable completely abuts against the locating plate. Then, the coaxial cable is 360-degree rotated to form a mark on the surface of the skin of the coaxial cable.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective view of a conventional cable stripper;

FIG. 1B is a sectional view of the conventional cable stripper;

FIG. 2 is a perspective view of the present invention;

FIG. 3 is a sectional view of the present invention;

FIG. 4 is a perspective exploded view of the present invention;

FIG. 5 is a sectional view of the present invention, showing that a pressing force is applied to the lower main body of the present invention to open the front ends of the upper and lower main bodies of the present invention;

FIG. 6 is a perspective view showing that a free end of a coaxial cable is inserted into the marking structure of the present invention;

FIG. 7 is a view showing that an annular reference line is formed on the surface of the skin of the coaxial cable in a proper position;

FIG. 8 is a view of the marking structure of a second embodiment of the present invention;

FIG. 9 is a sectional view showing that the marking structure of FIG. 8 is installed on the cable stripper of the present invention; and

FIG. 10 is a view showing that an annular pressmark is formed on the surface of the skin of the coaxial cable in a proper position.

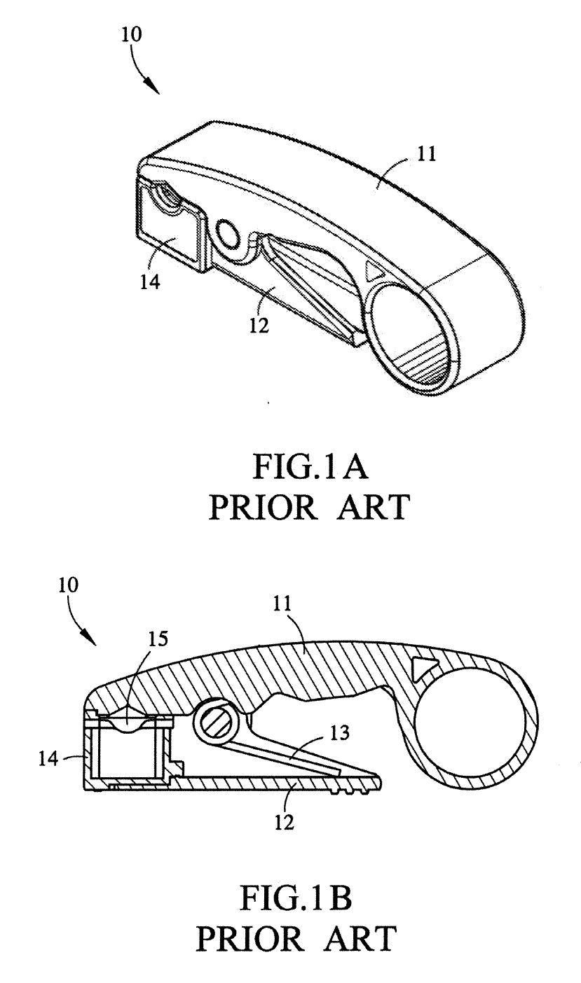

### DETAILED DESCRIPTION OF THE PREFERRED EMBODIMENTS

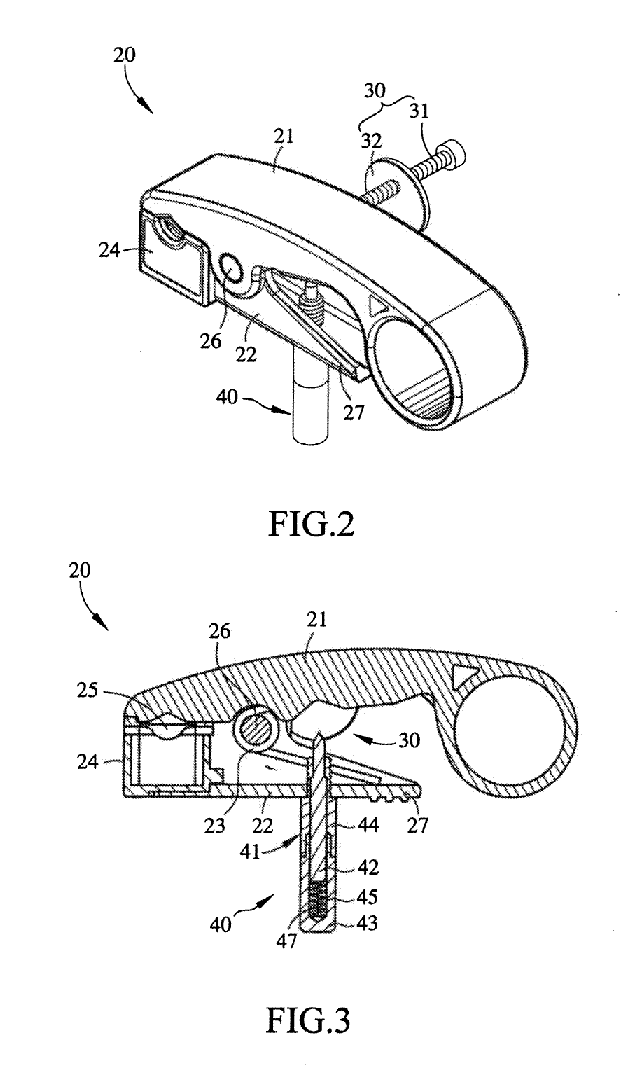

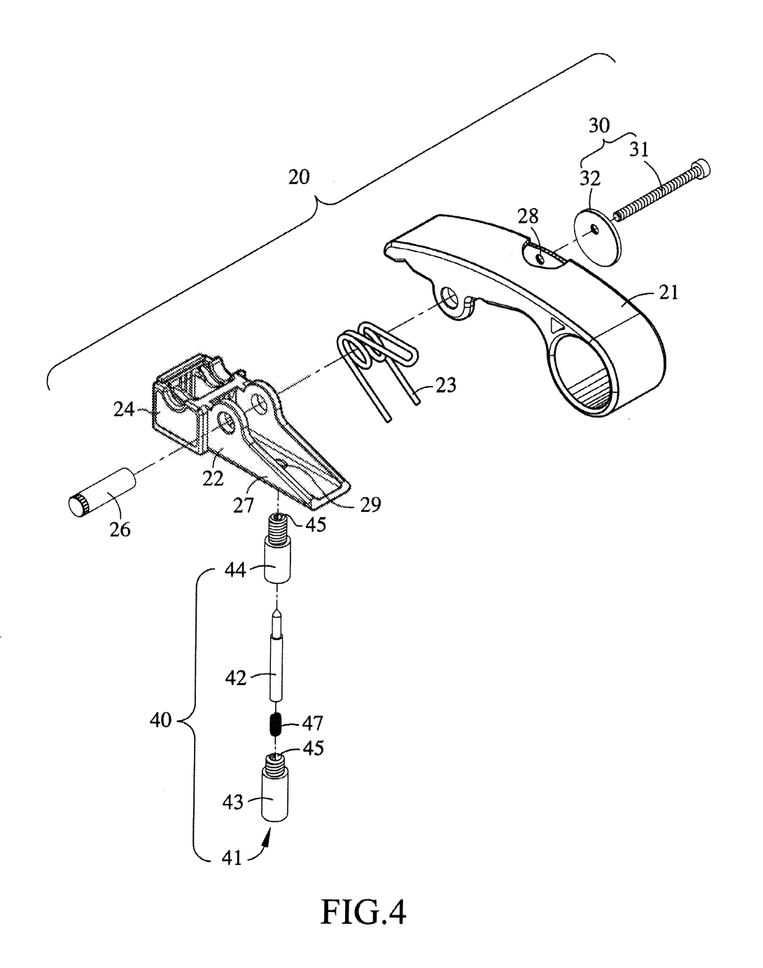

Please refer to FIGS. 2, 3 and 4. FIG. 2 is a perspective view of the present invention. FIG. 3 is a sectional view of the present invention. FIG. 4 is a perspective exploded view of the present invention. The cable stripper 20 with marking structure of the present invention includes an upper main body 21 and a lower main body 22 pivotally connected with the upper main body 21 and reciprocally movable relative to the upper main body 21. In practice, a pivot shaft 26 can be inserted through the upper and lower main bodies 21, 22, whereby the lower main body 22 can be rotated about the pivot shaft 26. The lower main body 22 has a press section 27 at its rear end. The cable stripper 20 further includes a blade seat 24 installed at a front end of the lower main body 22. A blade 25 is mounted on the blade seat 24. The cable stripper 20 further includes a micro-adjustable locating structure 30 connected with the upper main body 21, and a marking structure 40 connected with the lower main body 22. Preferably, a spring 23 is installed on the pivot shaft 26 with its two elastic ends respectively extending to the upper and lower main bodies 21, 22.

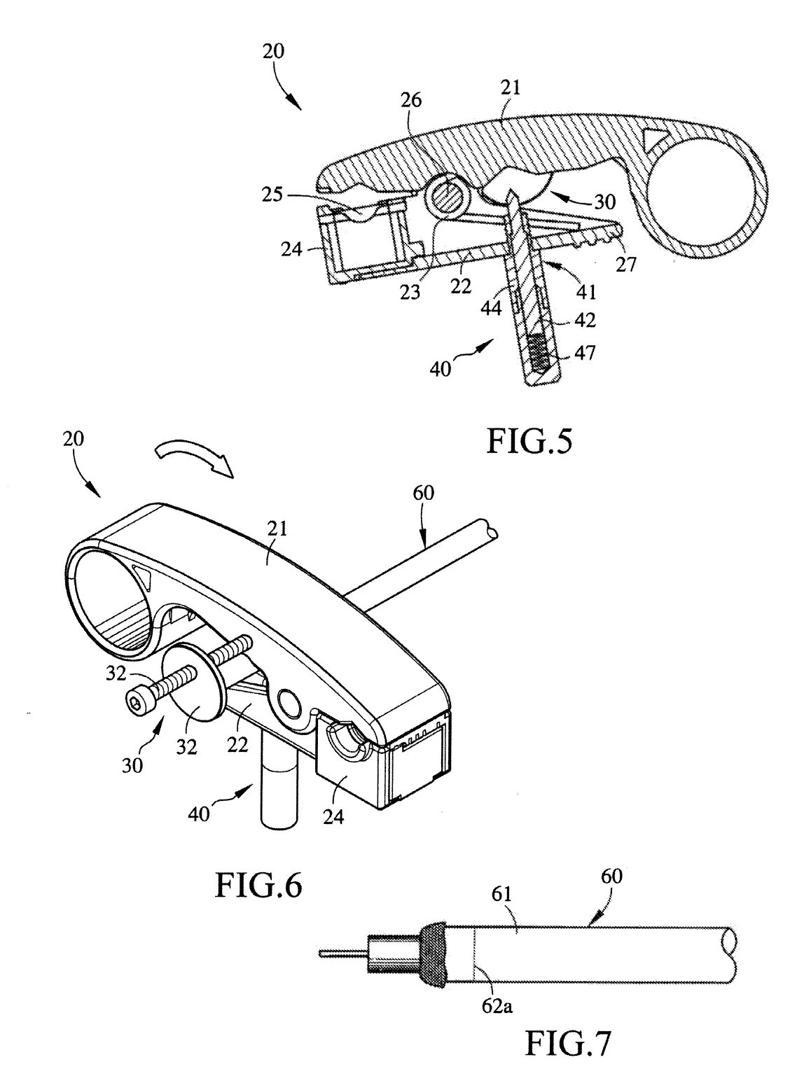

When not used, the front ends of the upper and lower main bodies 21, 22 of the cable stripper 20 are in a closed state as shown in FIG. 2. When a pressing force is applied to the press section 27 of the lower main body 22, the blade seat 24 is forcedly moved away from the front end of the upper main body 21, whereby the front ends of the upper and lower main bodies 21, 22 become in an open state as shown in FIG. 5.

The upper main body 21 has a first connection hole 28 formed in the middle of one side of the upper main body 21. The lower main body 22 has a second connection hole 29 formed on the press section 27.

The micro-adjustable locating structure 30 includes a fixing rod 31 and a locating plate 32 rotatably mounted on the fixing rod 31. The fixing rod 31 is a threaded rod, whereby the locating plate 32 can be moved back and forth along the fixing rod 31. The position of the locating plate 32 is adjusted in accordance with the diameter and variety of the coaxial cable. When the free end of the coaxial cable abuts against the locating plate 32, the coaxial cable is prevented from further advancing and is located.

The marking structure 40 includes a support body 41, which can be inserted into the second connection hole 29 of the press section 27 and affixed to the lower main body 22. The marking structure 40 further includes a marking member 42 mounted in the support body 41 and extending out of the support body 41 by a certain length.

The support body 41 includes a first tubular member 43 and a second tubular member 44 connected with the first tubular member 43 by means of screw connection. The interiors of the first and second tubular members 43, 44 together forma receiving hole 45 for receiving the marking member 42. An end of the second tubular member 44 is formed with a threaded section for connecting with the second connection hole 28 of the press section 27 so as to affix the marking structure 40 to the lower main body 22. The marking member 42 can be a pen or a rigid rod-shaped member for forming a mark on the skin of the coaxial cable in a proper position. When the ink of the pen is exhausted, the first tubular member 43 can be unscrewed to separate from the second tubular member 44. At this time, the pen can be replaced with a new one.

The marking structure 40 further includes a spring 47 disposed in the receiving hole 45 of the support body 41 under the marking member 42. Due to the spring 47, the marking member 42 is automatically telescopic to tightly abut against the skins of various coaxial cables in adaptation to different diameters thereof.

As shown in FIG. 6, a free end of a coaxial cable 60 can be inserted into the marking structure 40 until the free end of the coaxial cable 60 completely abuts against the locating plate 32. At this time, the coaxial cable 60 is 360-degree rotated to form a mark on the surface of the skin 61 of the coaxial cable 60 in a proper position, such as an annular reference line 62a (FIG. 7) or an annular pressmark 62b (FIG. 10). With the annular reference line 62a, the coaxial cable 60 is prepared to connect with and insert into the terminal connector by a correct insertion depth.

In practice, the mark serves as a judgment mark for judging whether the coaxial cable 60 is fully inserted into the terminal connector. In the case the coaxial cable 60 is fully inserted into the terminal connector, the annular reference line 62a will be flush with a rear end face of the terminal connector.

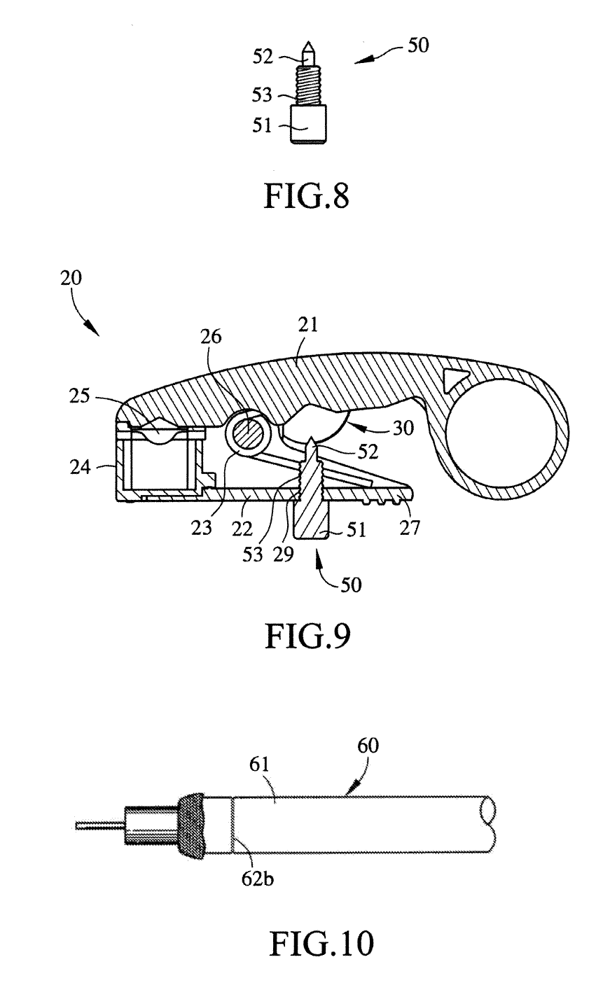

FIG. 8 shows a marking structure 50, which is applicable to the embodiment of FIGS. 2 to 7. The marking structure 50 is an integrated structure having a support body 51 and a marking member 52 disposed at one end of the support body 51. The support body 51 has a threaded section 53 for connecting in the second connection hole 29 of the lower main body 22 so as to affix the marking structure 50 to the cable stripper 20 as shown in FIG. 9. Similarly, by means of rotating the coaxial cable 60, an annular pressmark 62b can be formed on the surface of the skin 61 of the coaxial cable 60 in a proper position. When the coaxial cable 60 is fully inserted into the terminal connector, the annular pressmark 62b will be flush with the rear end face of the terminal connector.

The above embodiments are only used to illustrate the present invention, not intended to limit the scope thereof. It is understood that many changes or modifications of the above embodiments can be made by those who are skilled in this field without departing from the spirit of the present invention. The scope of the present invention is limited only by the appended claims.

What is claimed is:

1. A cable stripper with marking structure, comprising:
an upper main body having a first connection hole formed on one side of the upper main body;
a reciprocally movable lower main body connected with the upper main body, the lower main body having a second connection hole and a press section at a rear end of the lower main body;
a blade seat installed at a front end of the lower main body, when a pressing force is applied to the press section of the lower main body, the blade seat being forcedly moved away from the front end of the upper main body, whereby the front ends of the upper and lower main bodies become in an open state;
a micro-adjustable locating structure including a fixing rod connected in the first connection hole of the upper main body and a locating plate movably mounted on the fixing rod; and
a marking structure including a support body fixed in the second connection hole of the lower main body and a marking member connected with the support body and extending from the support body by a certain length, whereby a free end of a coaxial cable can be inserted into the marking structure until the free end of the coaxial cable completely abuts against the locating plate and then the coaxial cable is 360-degree rotated to form a mark on the surface of the skin of the coaxial cable in a proper position, with the mark, the coaxial cable being prepared to connect with and insert into a terminal connector by a correct insertion depth.

2. The cable stripper as claimed in claim 1, wherein the support body includes a first tubular member and a second tubular member connected with the first tubular member by means of screw connection, the interiors of the first and second tubular members together forming a receiving hole for receiving the marking member.

3. The cable stripper as claimed in claim 1, wherein the marking member is a pen for forming a mark of annular reference line on the surface of the skin of the coaxial cable in a proper position.

4. The cable stripper as claimed in claim 1, wherein the marking member is a rod-shaped member for forming a mark of annular pressmark on the surface of the skin of the coaxial cable in a proper position.

5. The cable stripper as claimed in claim 1, wherein the marking structure further includes a spring, whereby the marking member is automatically telescopic to tightly abut against the skins of various coaxial cables in adaptation to different diameters thereof.

6. The cable stripper as claimed in claim 1, wherein the marking member and the support body are integrally connected with each other.
